(19) United States
(12) Patent Application Publication
(10) Pub. No.: US 2003/0055924 A1
(43) Pub. Date: Mar. 20, 2003

(54) Method for downloading data

(76) Inventor: Kazuoki Matsugatani, Kariya-city (JP)

Correspondence Address: HARNESS, DICKEY & PIERCE, P.L.C., P.O. BOX 828, BLOOMFIELD HILLS, MI, 48303, US

(21) Appl. No.: 10/245,522

(22) Filed: Sep. 17, 2002

(30) Foreign Application Priority Data
Sep. 18, 2001 (JP) 2001-283615

(51) Int. Cl. G06F 15/16; G06F 15/177

(52) U.S. Cl. 709/220; 709/219

(57) ABSTRACT

A user accesses a control server using a web-browsing function provided in a cell phone to select purchase data, and sends an identification number specifying an in-vehicle device to be downloaded with the data. The control server sends a one-time password to the cell phone. The user inputs the one-time password into the in-vehicle device. When the in-vehicle device gets into one of download cells, such as a rail station, the ID and the one-time password are sent to the control server through an access point. The control server conducts conformation that the received ID and the one-time password are identical to those sent and received previously. When being confirmed as being identical, the requested data is delivered to the in-vehicle device through the access point.

### CROSS REFERENCE TO RELATED APPLICATION

This application is based upon Japanese Patent Application No. 2001-283615, filed on Sep. 18, 2001, the contents of which are incorporated herein by reference.

### BACKGROUND OF THE INVENTION

1. Field of the Invention

The present invention relates to a method for downloading data.

2. Related Art

As is disclosed in Japanese laid-open patent application JP-A-10-207710, when downloading of data is performed, that is, when a user get electrical data, the specifying of the data and the download of the data are performed by using a single device.

In these days, the amount of data tends to increase. Therefore, it is desirable to use a high speed communicating system for downloading. However, the servicing area forgetting electrical data through the high speed communication system (radio transmission system) is limited. Therefore, it is not useful to specify the data to be downloaded when the device is in a limited servicing area.

### SUMMARY OF THE INVENTION

An object of the present invention is for requesting a download of data anywhere and at anytime and automatically delivering the requested data to a specified mobile device such as an in-vehicle device, a hand-held device, a personal digital assistance or a laptop computer.

In a first aspect of the invention, a predetermined server, such as a control server, performs download of data to a mobile device by using a communication system. The mobile device may be carried in a vehicle, and is capable of communicating with the predetermined server through an access point. In this procedure, a request for the download of the data is performed by a hand-held device such as a cell phone. The cell phone is connected to a first communication network, such as a digital mobile cell phone network, and can communicate with the predetermined server connected to a second communication network, such as a random accessible type network, i.e., the Internet, through the first network. In this method, a request from the hand-held device requesting the download of data is received, and the specified information is received that specifies a mobile device to be downloaded with the data. Specified information, which is sent from the mobile device is received when the mobile device is located in anyone of the download cells, each of which is discrete from the others through an access point for performing communication with the mobile device. The specified information received in the download cell is reviewed to determine if it is identical to the specified information received previously. When it is determined that it is identical, the requested download data is delivered to the mobile device through the access point.

The digital mobile cell-phone communication network serves as the first network used by a user who contracts with the first network, and also serves so that the user can generally use it anywhere. By using the hand-held device, the user can request the data to be downloaded generally anywhere, at anytime. When the mobile device gets into any one of the download cells, the specified information of the mobile device is confirmed as being identical to the specified information previously received from the mobile device. When it is confirmed as being identical, the requested data is delivered to the mobile device.

Preferably, the hand-held device is a mobile cell phone. The user thereof engages with the first network, and can be charged by using information such as his/her phone number. Therefore, the user is provided high security in comparison with the electric charging thought the Internet.

Preferably, when the request and the specified information are received that are sent from the mobile device, a reservation notice is sent to the mobile device for certifying the mobile device to be downloaded by using the reservation notice with the specified information. This ensures that the data is sent to the mobile device to which the data is to be downloaded.

Preferably, when the downloading is interrupted, the downloading is resumed when the mobile device gets into one of the download cells after the specified information is determined as being identical to the previous one that was received when the mobile device sent the request.

Preferably, the download data is sent from a cache server through the access point that can store the data identical to that stored in the predetermined server.

Preferably, the download data is sent to cache servers located in an area where a hand-held device might exist.

Preferably, a purchase reservation server is provided that is connected to the first network so as to send the request for the download data and the specified information for the mobile device to be downloaded with data to the predetermined server, thereby improving the security of communication.

According to second aspect of the invention, in a downloading method in which download data requested from a hand-held device for a first network that is used by a user who contracts with the first network is sent to a mobile device, a request for the download of data that is sent from the hand-held device, and specified information for specifying the mobile device to which the data is to be downloaded is also sent form the hand-held device. The specified information, which is sent from the mobile device later, when the mobile device is in any one of download cells each of which is discrete from the others, is received and confirmed whether being identical to the specified in formation received previously. When it is determined as being the same, the requested data is automatically delivered to the specified mobile device.

Other features and advantages of the resent invention will become more apparent from the following detailed description made with reference to the accompanying drawings.

### BRIEF DESCRIPTION OF THE DRAWINGS

FIG. 1 is a diagram showing an information delivery system for a mobile object in a first embodiment of the present invention;

FIG. 2 is a sample process in a case where data is sent to an in-vehicle unit using a cell phone of the first embodiment of the present invention;

FIG. 3 is a process subsequent from that shown in FIG. 2 of the first embodiment of the present invention;

FIG. 4 is a process in a case where emergency information is downloaded in the first embodiment of the present invention;

FIG. 5 is a diagram showing another type of an information delivery system for a mobile object in the first embodiment of the present invention;

FIG. 6 is a diagram showing an information delivery system for a mobile object in a second embodiment of the present invention;

FIG. 7 is a sample process in a case where data is sent to an in-vehicle unit using a cell phone of the second embodiment of the present invention;

FIG. 8 is a process subsequent from that shown in FIG. 2 of the second embodiment of the present invention;

FIG. 9 is a process in a case where real-time information emergency information is downloaded in the second embodiment of the present invention;

FIG. 10 is a diagram showing an information delivery system for a mobile object in a third embodiment of the present invention;

FIG. 11 is a diagram showing another type of an information delivery system for a mobile object in the third embodiment of the present invention;

FIG. 12 is a diagram showing a characterized process in the third embodiment of the present invention;

FIG. 13 is a functional diagram of a first sample of an in-vehicle unit; and

FIG. 14 is a functional diagram of a second sample of an in-vehicle unit.

### DETAILED DESCRIPTION OF THE PREFERRED EMBODIMENT

Specific embodiments of the present invention will now be described hereinafter with reference to the accompanying drawings in which the same or similar component parts are designated by the same or similar reference numerals.

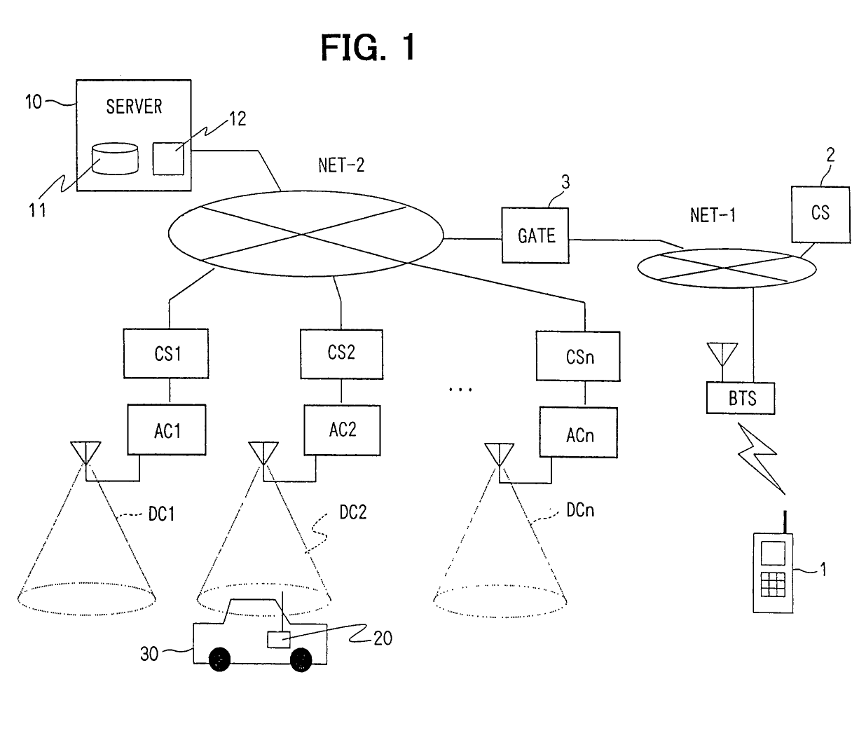

A first preferred embodiment of the present invention will be now described with reference to FIGS. 1 to 5. An information delivery system for a mobile object includes a data transmittable network in which a first radio transmission system which has a first network used by a user who engages with the network is connected to a second radio transmission system connected to a random accessible type public network such as the Internet. The random accessible type public network is a conventional type. In this delivery system, electric data such as data software, many kinds of information, motion pictures, games (hereinafter, referred to as “data”) can be delivered to an in-vehicle device using a web-browseable cell phone (handy-phone) capable of browsing web sites.

In the first radio transmission system, each Base Transceiver Station (referred to as “BTS”) that performs radio communication with a cell phone 1 and a control device 2 of a telecommunications company (cell phone controlling device) are connected to a cell phone communication network NET-1. The cell phone controlling device 2, as a conventional device, monitors the use of each cell phone to collect (charge) a telephone bill in this embodiment. The cell phone communication network NET-1 is connected to the Internet NET-2 through a gate way 3 to maintain security for the first radio transmission system.

In the second radio transmission system, a control server 10 and each cache server CS1, CS2, . . . , CSn are connected to the Internet. The control server contains a memory 11 for storing various types of data such as commercial products and a retrieval agent 12 for collecting information from the Internet in association with a request from a user, and sends data to be downloaded for the user to the cache server. Each cache server CS1, CS2, . . . , CSn stores the data sent from the control server 10, and downloads the data to an in-vehicle device 20 through each access point AC1, AC2 . . . , ACn when located within each download cell DC1, DC2, . . . , DCn where the access point is connected to the cache server. The access point is located at many discrete places such as a gas station, a parking lot of a convenience store and a traveling road, and has a communicating apparatus capable of performing high-speed and high-capacity communication with the in-vehicle device 20 using a DSRC or the like.

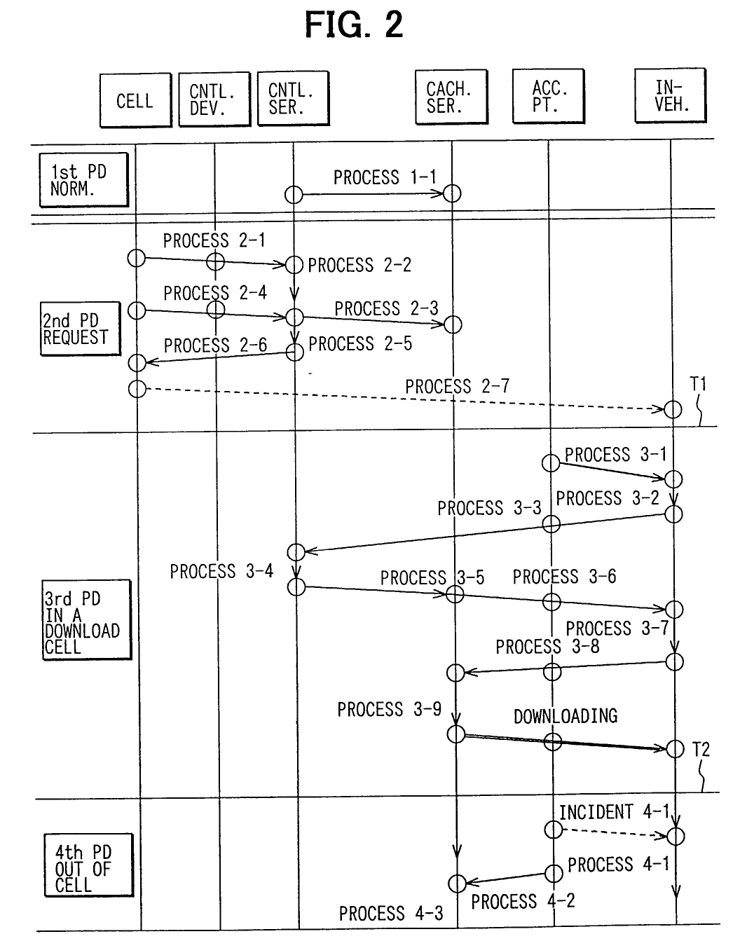

The procedure for sending data to the in-vehicle device 20 using the cell phone 1 in the information delivering system for the mobile object will be explained with reference to FIGS. 2 to 4.

FIG. 2 shows each process in connection with the cell phone 1 (CELL), the control device 2 (CNTL. DEV.), the control server 10 (CNTL. SER.), the cache server CS (CACH. SER.), the access point AC (ACC. PT) and the in-vehicle device 20 (IN-VEH.).

In a first period (1^{st} PD) as a normal delivery period, the control server 10 delivers the same data memorized therein to the cache servers CS1, CS2, . . . , CSn so as to memorize the same date (PROCESS 1-1).

In a second period (2^{nd} PD) as a user request period, when the user wants to get the data to the in-vehicle device 20, the user communicates with the BTS using the cell phone 1 at first to connect with the control server 10 from the BTS through the cell phone communication network NET-1, the gate way 3 and the Internet NET-2. The user accesses merchandise purchase pages using the web-browsing function of the cell phone to select the merchandise (data) to be purchased (PROCESS 2-1).

When the request from the cell phone 1 is a request for retrieving data, the control server 10 conducts retrieval of the data by activating the retrieval agent 12 to get it from the Internet NET-2 and store it therein (PROCESS 2-2), and the control server 10 delivers retrieval result to the cache servers CS1, CS2, . . . and CSn (PROCESS 2-3). When the request is not the request for retrieving data, the retrieval and the delivery are not performed. After that, the user sends an identification number (ID) of the in-vehicle device 20 to be downloaded with the data (PROCESS 2-4).

The control server 10 confirms the user by using a sender address as a user specifying information (a phone number of the cell phone, hereinafter, referred to as a sender number) that is transmitted from the cell phone control device 2 (PROCESS 2-5), and sends a one-time password indicative of a purchase reservation number for the purchase data to the cell phone 1 (PROCESS 2-6). Then, the one-time password is input to the in-vehicle device 20. This input can be manually performed by the user or can be performed using an in-vehicle LAN described later (PROCESS 2-7).

The vehicle 30 will then get into a download cell DC1, DC2, . . . or DCn for the first time after the request of purchase at a time T1.

In a third period (3rd PD) as a download cell period, each access point AC1, AC2, . . . or ACn periodically sends radio waves to respective download cells DC1, DC2, . . . and DCn for detecting the existence of the in-vehicle device 20 therein. When the vehicle 30 gets into any one of download cells DC1, DC2, . . . and DCn (in this case, into the download cell DC2), and the in-vehicle device 20 detects the radio waves delivered from the access point AC2 (PROCESS 3-1), the in-vehicle device 20 performs an initial process for its radio transmission system (PROCESS 3-2), and then, delivers its ID and the one-time password to the control server through the access point AC2 (PROCESS 3-3).

The control server 10 confirms whether the ID and the one-time password both of which sent from the in-vehicle device 20 are identical to those of the user who made a reservation for purchase previously (i.e., matching confirmation). When it is determined that they match, a download starting flag is set (PROCESS 3-4). After that, the control server 10 sends information showing they match and a download file list to the cache server (PROCESS 3-5). The download file list is a list for data to be downloaded.

The cache server CS2 sends the file list to the in-vehicle device through the access point, and prepares the downloading of the data in the list and waits (PROCESS 3-6). The in-vehicle 20 sets the file list (PROCESS 3-7), and then, sends a request for downloading the data from the top of the list to the cache server CS2 through the access point AC2 (PROCESS 3-8). The cache server confirms whether the contents of the download request matches the file list in association with the request (PROCESS 3-9). When it is determined that the download request matches the file list, the data is delivered to the in-vehicle device 20 through the access point AC2.

The downloading of the data is performed as described above, and the in-vehicle device 20 stores the data. The access point AC2 periodically sends radio waves to check whether the vehicle 30 is in the download cell DC2 and recognizes that the vehicle 30 is in it by receiving response radio waves from the in-vehicle device 20 that is a response to the radio waves from the access point AC2.

When the download of data is completed, then, post-download process is performed. On the other hand, should the in-vehicle device 20 get out of the download cell DC2 while downloading at a time T2 in a fourth period (4^{th} PD) as an out of cell period, the in-vehicle device 20 cannot receive radio waves from the access point AC2 (INCIDENT 4-1). The in-vehicle device 20 memorizes an interrupted portion of the download (PROCESS 4-1). Moreover, the access point AC2 recognizes not to receive the response radio waves from the in-vehicle device 20, and informs that to the cache server CS2 (PROCESS 4-2). The cache server CS2 stops downloading the data based on the information (PROCESS 4-3).

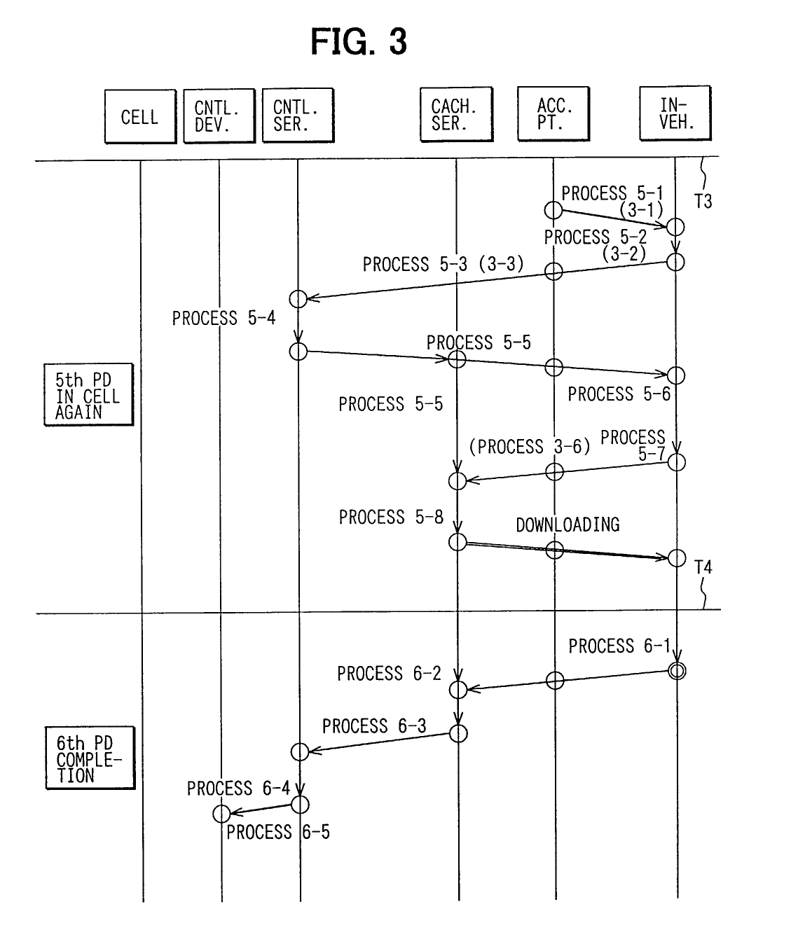

FIG. 3 shows processes after interrupting the download. In a fifth period (5^{th} PD) as a reenter period, when the in-vehicle device gets into another (might be the same) download cell, for example, a download cell CS1 at a time T3, and the in-vehicle device detects the radio waves delivered from an access point AC1 (PROCESS 5-1), delivers its ID and the one-time password to the control server through the access point (PROCESS 5-3) after initialization (PROCESS 5-2). The control server 10 performs matching of the ID and the one-time password with previous ones. When it is determined that they match, the control server 10 recognizes that the download of the data has been interrupted based on the download starting flag (PROCESS 5-4), and informs a cache server CS1 for resuming the download (PROCESS 5-5). Incidentally, the cache server CS1 at this time is the one connected to the access point AC1 which currently communicates with the in-vehicle device 20.

The cache server CS1 informs the in-vehicle device 20 of the resuming the download through the access point AC1, and prepares the downloading. The in-vehicle device 20 calls the interrupted portion of the download (PROCESS 5-6), sends a download request that requires the downloading of the data from its midstream by designating the interrupted portion (PROCESS 5-7). The cache server CS1 calls the interrupted portion in accordance with the request (PROCESS S-8), and then, sends the data to the in-vehicle device 20 through the access point AC1.

In a sixth period (6^{th} PD) as a completion period, when the downloading of the data is completed at a time T4, the in-vehicle device 20 informs the completion of the download to the cache server CS1 through the access point AC1 (PROCESS 6-1). The cache server CS1 performs an end process of the deliver of the data (PROCESS 6-2), and informs the completion of the download to the control server 10 (PROCESS 6-3). The control server 10 resets the download starting flag in accordance with the information (PROCESS 6-4), performs a charging process to inform the cell phone control device 2 of charging for the download of the data (PROCESS 6-5). The fee of the download of the data is charged to the sender number of the cell phone 1 which is used for the purchase request.

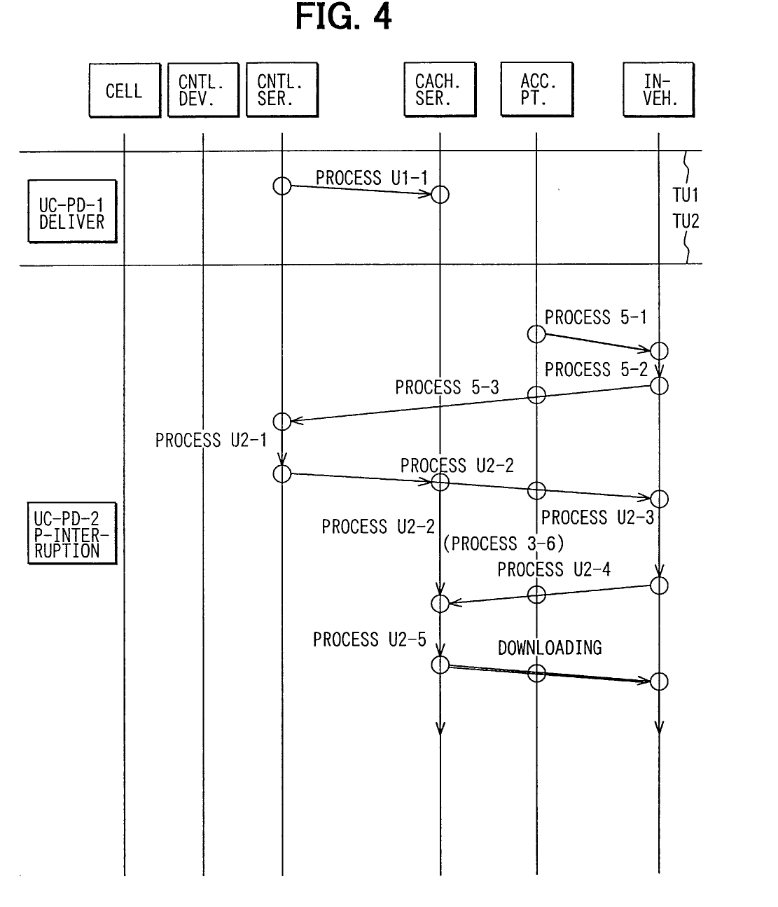

In this embodiment, in a case where urgent information, which has high immediacy such as information relating to traffic-delay caused by an accident or closure of the road occurs, the urgent information can be sent to the in-vehicle device 20. The process will be described with reference to FIG. 4.

In an urgent case period one (UC-PD-1) as an urgent information deliver period, assume that the information having high immediacy should be sent at a time TU1. The control server 10 sends the urgent information to the cache servers CS2 (PROCESS U1-1). Here, assume that the in-vehicle device 20 gets into the download cell CS1 at a time TU2 after having the downloading of the data at the download cell CS2 interrupted in an urgent case period two (UC-PD-2) as a post-interruption period.

The in-vehicle device delivers its ID and the one-time password to the control server 10 through the access point AC1 (PROCESS 5-3) after initialization (PROCESS 5-1). The control server 10 performs matching of the ID and the one-time password with previous ones. When it is determined that they match, the control server 10 informs the in-vehicle device 20 of the download regarding the urgent information through the access point AC1 (PROCESS U2-2).

In this case, the file list is changed to include the urgent information (PROCESS U2-3). After that, a download request is sent from the in-vehicle device 20 to the cache server CS1 (PROCESS U2-4), then, the cache server CS1 prepares the delivery of the urgent information (PROCESS U2-5) and delivers the data of the urgent information through the access point AC1. After the download of the urgent information is completed, the download of the data will be resumed as described above.

Even if the in-vehicle device 20 gets into any one of the download cells DC1, DC2, . . . , DCn for the first time, such urgent information is delivered preferentially. The user can get the urgent information when the in-vehicle device 20 can display and/or announce it based on its deliver described above.

An in-vehicle device 20 that has not made a reservation for purchase of data may be able to receive the urgent information. For example, when an in-vehicle device 20 capable of receiving the data gets into any download cell, it can receive the urgent information by eliminating the matching confirmation process such as PROCESS 3-4 or 5-4.

According to the above-described embodiment, in the second radio transmission system, respective cache servers CS1, CS2, . . . , CSn are connected to each access point AC1, AC2, . . . or ACn, and also connected to the control server 10 through the Internet. The control server 10 delivers various kinds of data periodically to the respective cache servers CS1, CS2, . . . , CSn. The download to the in-vehicle device 20 can be achieved through each cache server connected to each access point, not through the Internet. Moreover, the control server 10 delivers the data periodically to each cache server at a timing different from that of a download request from a user. Therefore, the load in the network can be reduced.

Since the data is sent from the cache server connected to the access point while downloading, even if the rate in the second radio transmission system is fast, the communication rate in a wired portion does not become a bottleneck of the rate.

Since the reservation for purchase of the data is performed using the first radio transmission system having a wide servicing area, the reservation can be conducted generally anywhere, at anytime. The data reserved for purchase is automatically delivered to the in-vehicle device using the second radio transmission system capable of high speed communication. The second radio transmission system which administrates the download can be connected through the Internet. Therefore, it is easy to construct a network.

Since the charging of the fee can be carried out in the first radio transmission system, the bill can be addressed to the phone number of the cell phone. Therefore, this charging has high security as compared to the electric charge using the Internet, and is more convenient to the user.

When the request of the user is data corresponding to a retrieval formula, and the user designates retrieval contents, the retrieval agent integrated in the control server performs the retrieve, and sends the retrieval result to the cache server. Therefore, by using the retrieval agent, appropriate information for the user can be retrieved. Moreover, the information stored in the server can be reduced so as to provide various information to the user.

In a procedure for purchasing the data by the user, a one-time password is provided to the user, and the control server conducts the confirmation that the one-time password and the ID already stored are identical to those sent from the user. Namely, damage when the password is stolen can be reduced by using the one-time password. The download can be administrated with different password at every purchase procedure by the user. Therefore, the control server can recognize when that procedure is performed. Moreover, by using a one-time password, the download can be continued even when the in-vehicle device gets into a download cell again after leaving one.

The urgent information having important information such as traffic delay caused by an accident or closure of a road can be delivered preferentially as compared to a normal download procedure so that the user can be informed of such urgent information.

Although the control server delivers various types of data to each cache server in this embodiment, when the user designates the data he/she wants to get, the control server can deliver it to the cache server. There is a time-lag in a situation where after the user designates the data, the user drives the vehicle, and then, the vehicle gets into any one of download cells. Therefore, this time-lag can be useful for delivering the data to the cache server. By this method, the load in the network can be reduced.

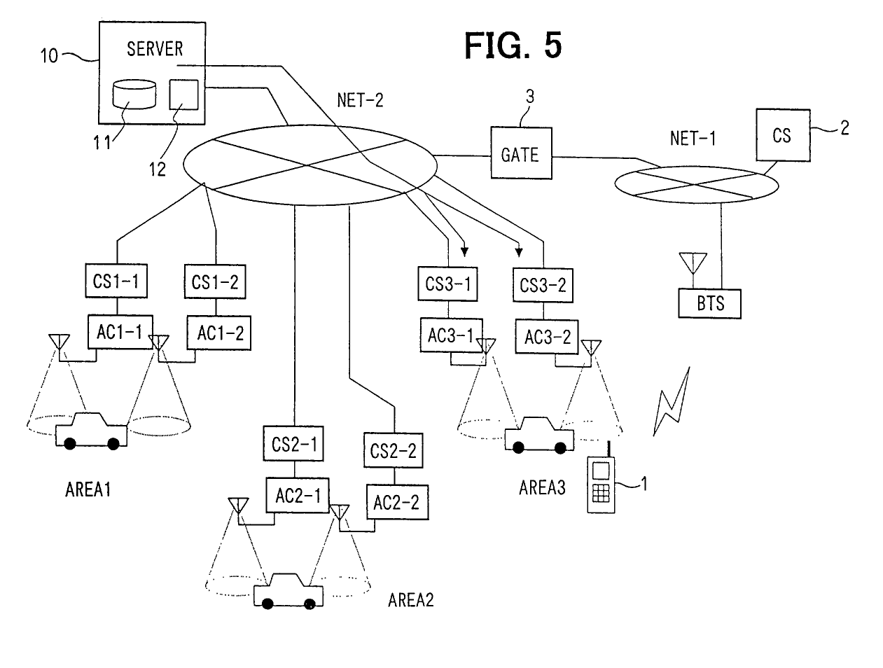

In the above-mentioned embodiment, when the amount of data to be downloaded increases and the system become large, it is not efficient that all cache servers CS1, CS2, . . . and CSn have identical data. Therefore, as shown in FIG. 5, when the user designates the data using the cell phone 1, the data is delivered to cache servers connected to access points only located in an area where the cell phone 1 exists according to the information from BTS which communicates with the cell phone 1. For example, the data is delivered to the cache servers CS2-1, CS2-2 in an area 2. Therefore, efficiency of deliver of data can be improved with this way.

As described below, the data can be delivered to the in-vehicle device from the control server through the access point without going through the cache server.

In the above-described embodiment, although the interrupted portion of the download is memorized in the in-vehicle device, that portion can be memorized in the control server instead of the in-vehicle device.

In a situation where the user inputs the one-time password into the in-vehicle device, the security for inputting the one-time password can be strengthened by using the setting such that it cannot be input when a password for the in-vehicle device that is set previously by the user or the like is not input. For example, there is possibility in which a despicable person conducts procedure for purchase of data, and designates a predetermined in-vehicle device as an object to which the data is to be downloaded so as to send a virus program that has adverse affect on the in-vehicle device. In this case, when inputting the one-time password, if the in-vehicle device conducts confirmation of the password specialized in it or the like, the fraud described above can be prevented.

(Second Embodiment)

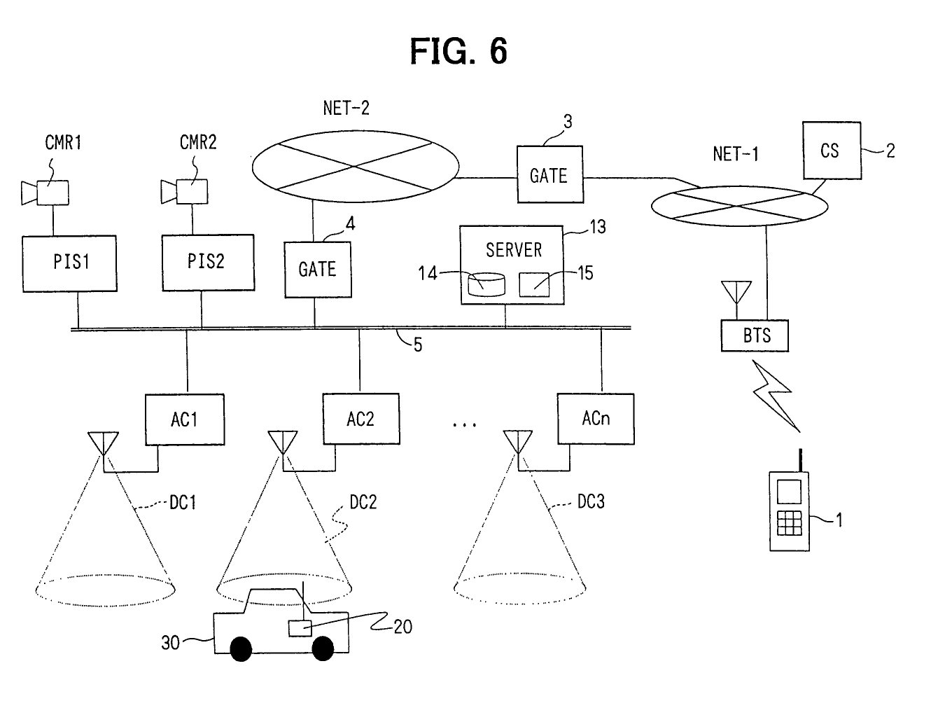

In the first embodiment, the data stored previously or the data retrieved based on the request from the user is delivered to the in-vehicle device. In addition to this delivery, real time information such as a picture image of a traffic intersection can be delivered. The delivery of the real time information will be described with FIGS. 6 to 9.

FIG. 6 shows an information delivery system for a mobile object of the second embodiment. A control server 13 having a memory 14 and a retrieval agent 15 is connected to access points through an exclusive backbone 5 (backbone line), and connected to the Internet (NET-2) through a gate way 4. Picture image delivering servers, such as PIS1 and PIS2, are connected to the exclusive backbone 5 as real time servers (hereinafter, refereed to as a picture image server). Each picture image server gets real time information from a camera such as CMR1 or CMR2, and delivers it. Incidentally, cache servers are not provided in this embodiment. Other features are the same as those in the first embodiment.

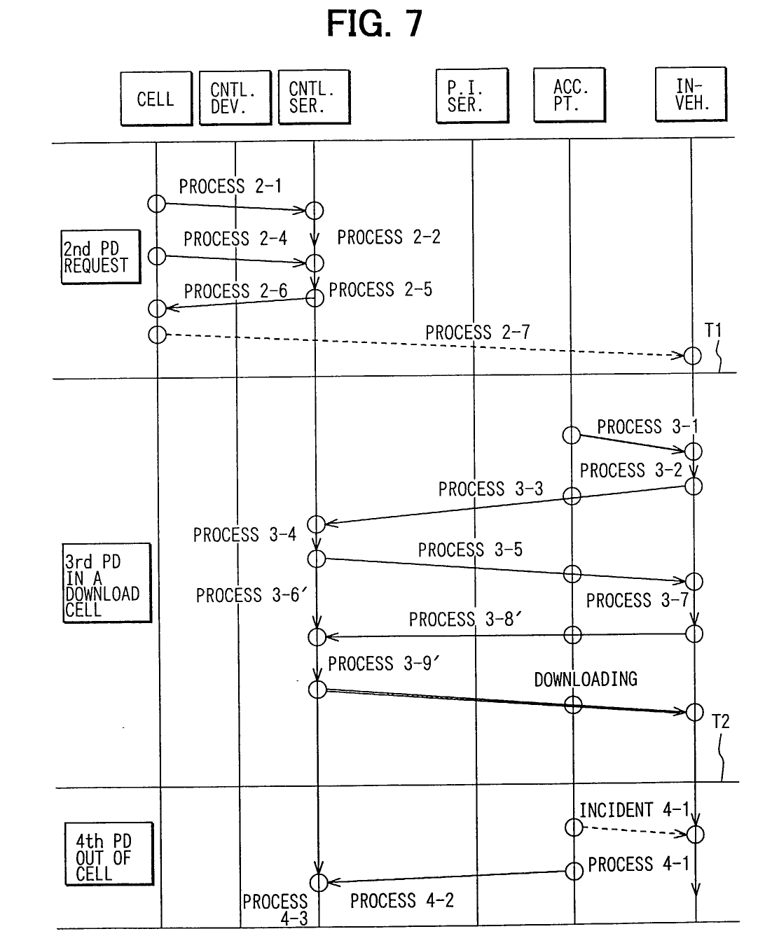

The procedure for sending data to the in-vehicle device 20 using the cell phone 1 in the information delivering system for the mobile object will be explained with reference to FIGS. 7 to 9.

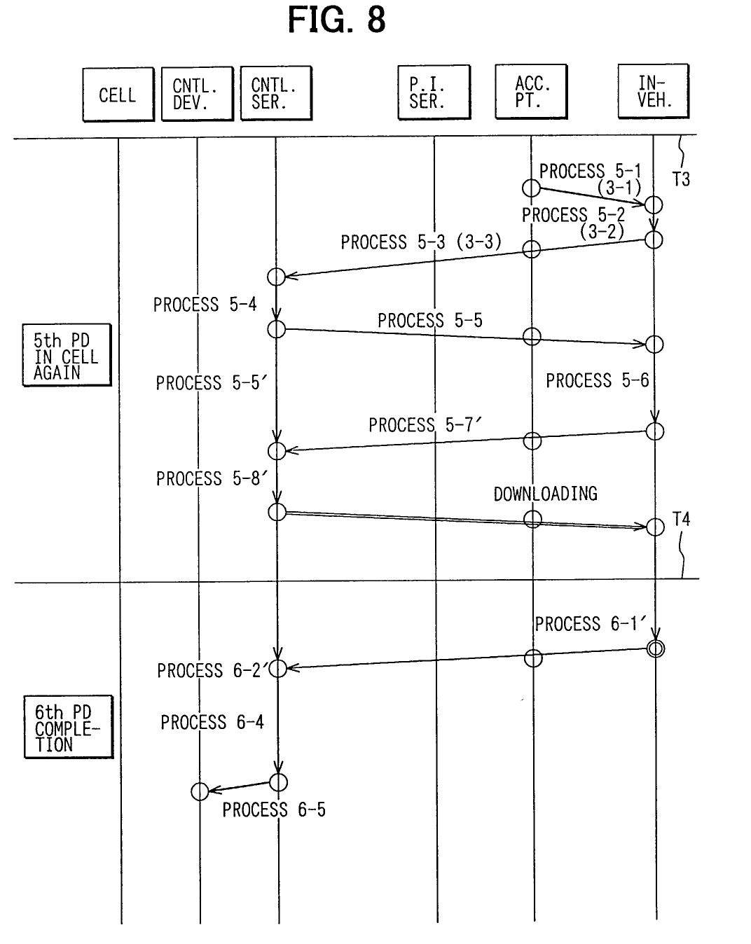

FIGS. 7 and 8 are similar diagrams to those shown in FIGS. 2 and 3, and shows a process in a case where a user would send data to an in-vehicle device 20 using a cell phone 1. In this embodiment, the control server 13 downloads the data to the in-vehicle device 20 though the exclusive backbone 5 and the access point, for example, AC2. Therefore, this procedure has almost the same processes as those in the first embodiment except the processes regarding the cache servers. Therefore, description for FIGS. 7 and 8 will be omitted. For easily understanding, the processes are shown in FIGS. 7 and 8 that are the same those as in FIGS. 2 and 3. In FIG. 7, the first period shown in FIG. 2 is omitted. FIGS. 7, 8 do not show any process relating to the picture image server. Therefore, processes conducted by the control server 13 instead of by the cache server are shown with prime on a process number.

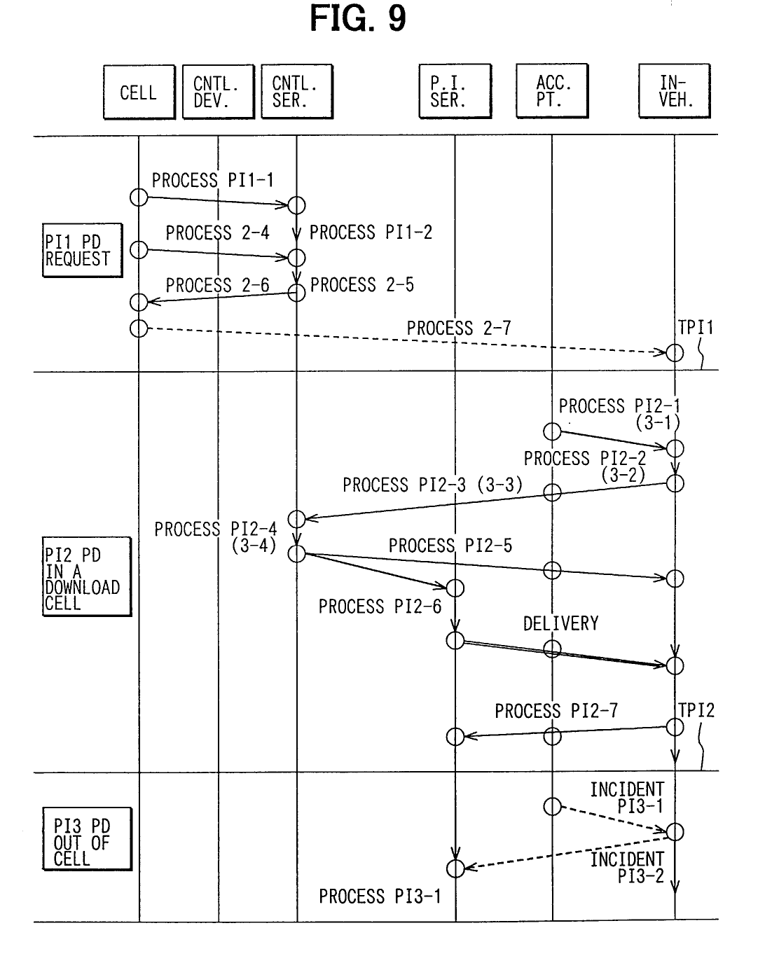

FIG. 9 shows a diagram in a situation where the user wants to get special picture images. Description for some of similar processes to the first embodiment will be omitted.

In a picture-image first period (PI1 PD) as a user request period, the user accesses product purchase pages in the control server 13 using the web-browseable cell phone 1, and chooses delivering information (PROCESS PI1-1). The control server 13 selects the picture image server (P.I. SER.) that can deliver the delivering information based on the information chosen by the user (PROCESS PI1-2). After that, similar to the first embodiment, the user sends an identification number (ID) of the in-vehicle device 20 to be downloaded with the data (PROCESS 2-4). The control server 10 confirms the user based on the sender number (PROCESS 2-5), and sends a one-time password to the cell phone 1 (PROCESS 2-6). Then, the one-time password is input to the in-vehicle device 20 (PROCESS 2-7).

Assume that the vehicle 30 gets into a download cell DC1, DC2, . . . or DCn for the first time after the request of purchase at a time TPI1.

In a picture-image second period (PI2 PD) as a download cell period, when the vehicle 30 gets into any one of download cells DC1, DC2, . . . and DCn (in this case, into the download cell DC2), the in-vehicle device 20 delivers its ID and the one-time password to the control server through the access point AC2 (PROCESS PI2-3) The control server conducts matching confirmation based on the ID and the one-time password (PROCESS PI2-4). When it is determined that they match, the control server 13 sends information showing they match and an address of the picture image server to the in-vehicle device through the access pint AC2 (PROCESS PI2-5), and also sends an address of the access point AC2 to the picture image server (PROCESS PI2-6). After that, delivery of picture images will start being sent from the picture image server to the in-vehicle device 20.

In this case, the delivery of the data can be performed by broadcast or multicast. When the broadcast is used, the picture image server delivers the data to every access point. On the other hand, when the multicast is used, the picture image server delivers the data only to the access point whose address is informed to the picture image server. The in-vehicle device gets the data using the informed address of the picture image server.

The in-vehicle device 20 periodically sends notice for receiving confirmation. With this notice, the picture image server can recognize that the in-vehicle device 20 is in the download cell DC2 (PROCESS PT2-7), and the picture image server continues to send the picture image data.

When the in-vehicle device 20 leaves the download cell DC2 while downloading at a time TPI2 in a picture-image three period (PI3 PD) as an out of cell period, the in-vehicle device 20 cannot receive the radio waves from the access point AC2 (INCIDENT PI3-1) Therefore, the picture image server cannot receive the notice for receiving confirmation from the in-vehicle device (INCIDENT PI3-2). With this condition, the picture image server recognizes that the in-vehicle device left the download cell, and then, stops delivering the data (PROCESS PI3-1). After that, the picture image server informs the control server 13 of termination of delivery of the data. The control server conducts a charging process based on that information.

According to this embodiment, by connecting the control server and the access points through the exclusive backbone, communication between the control server or the picture image server and the access points can be performed at high speed. Therefore, the real time information, for example, information picturizing an intersection can be serviced to the in-vehicle device.

In this embodiment, similar to the first embodiment, cache servers can be provided.

The time restriction for receiving the picture image data can be provided so that the in-vehicle device receives the picture image data during a predetermined time or a time user requested while being in the download cell.

(Third Embodiment)

In the first and second embodiments, when the user wants to purchase the merchandise, the user connects the cell phone to the control server to access the merchandise purchase pages and choose the merchandise. Therefore, the cell phone continues to be connected to the control server until the merchandise purchase procedure is completed. This situation may cause a problem on the security. In this embodiment, the problem can be eliminated.

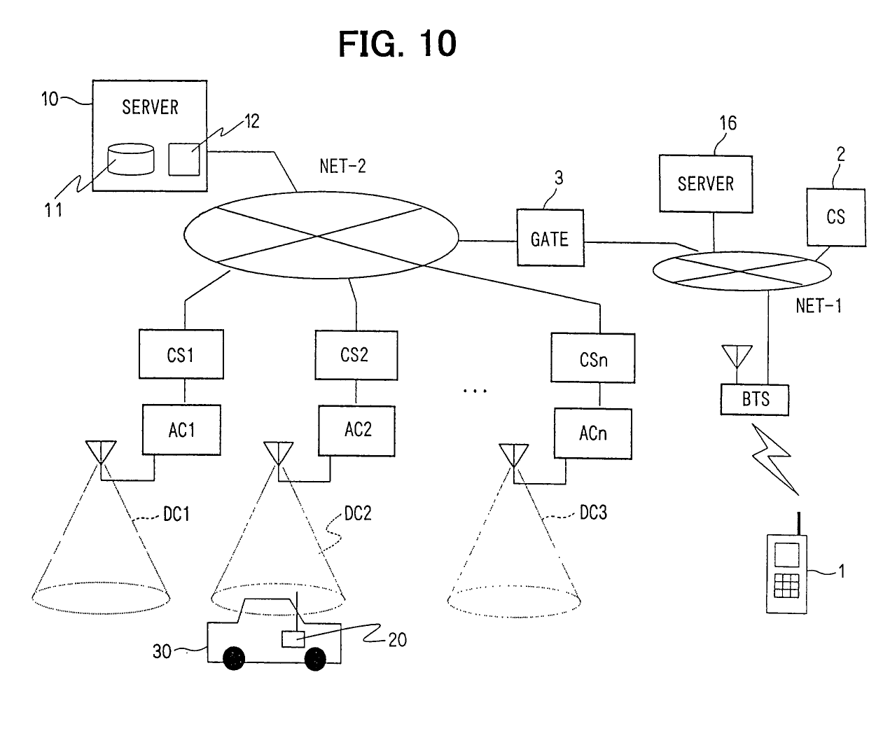

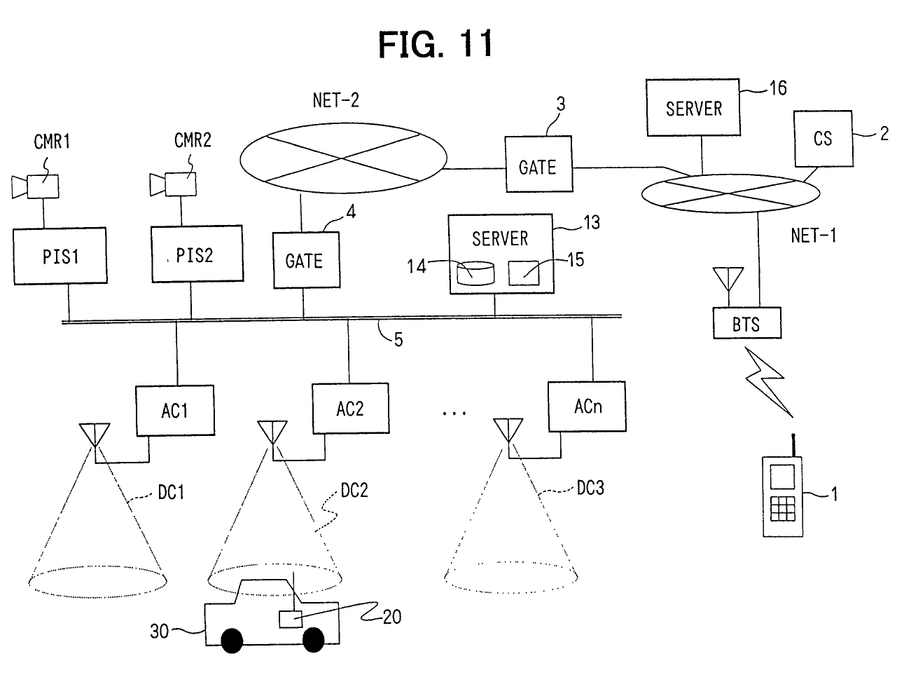

As shown in FIGS. 10 and 11, a purchase reservation server 16 is provided in the cell phone communication network NET-1 so that the user accesses the purchase reservation server 16 from the cell phone to make a reservation for the purchase of merchandise, and the purchase reservation server 16 sends information only of the reservation for the purchase to the control server 10. FIG. 10 shows a diagram in which the purchase reservation server 16 is applied to the diagram shown in FIG. 2 of the first embodiment. FIG. 11 shows diagram in which the purchase reservation server 16 is applied to the diagram shown in FIG. 6 of the second embodiment.

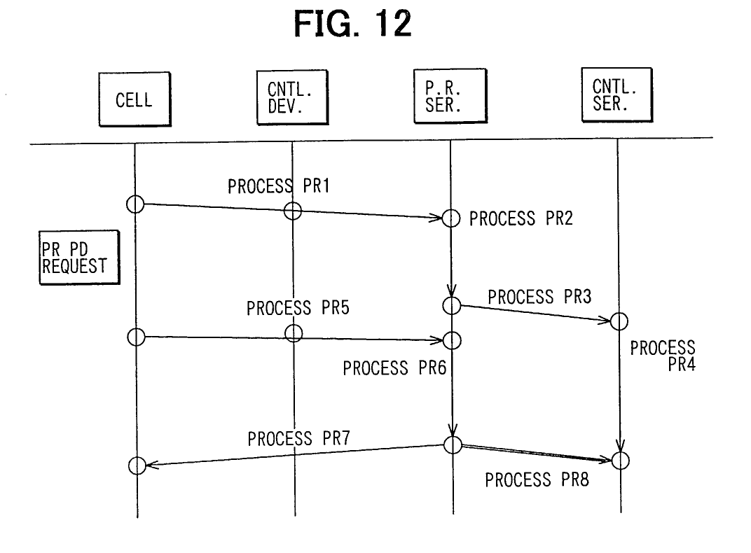

FIG. 12 shows a diagram explaining a characterizing portion in the third embodiment. When a user wants to purchase merchandise, the user accesses the merchandise purchase pages in the purchase reservation server 16 (P.R. SER.), and choose the merchandise he/she wants (PROCESS PR1). The purchase reservation server 16 detects a sender number, receives the request from the user (PROCESS PR2), and informs the control server 10 (13) of the request from the user (PROCESS PR3). The control server 10 (13) conducts a process based on the request from the user. For example, when the request from the cell phone 1 is a request for retrieving data, the control server 10 conducts retrieval of the data by activating the retrieval agent 12 to get it from the Internet NET-2 (PROCESS PR4).

After the user sends an identification number (ID) of the in-vehicle device 20 to be downloaded with the data (PROCESS PR5), the purchase reservation server 16 confirms the user by using a sender number (PROCESS PR6), and sends a one-time password to the cell phone 1 (PROCESS PR7). Also, the purchase reservation server 16 sends the ID and the one-time password to the control server 10 (13) (PROCESS PR8). In this case, the ID and the one-time password are sent by preferably being coded using public-key cryptography. The following processes are the same as those of the first or the second embodiment.

In this embodiment, the procedure for purchasing the data by the user is performed within the network used by a user who contracts with it, and the control server gets information only necessary for the reservation. Therefore, the possibility that operations by the user leak to others can be lowered, thereby improving the security.

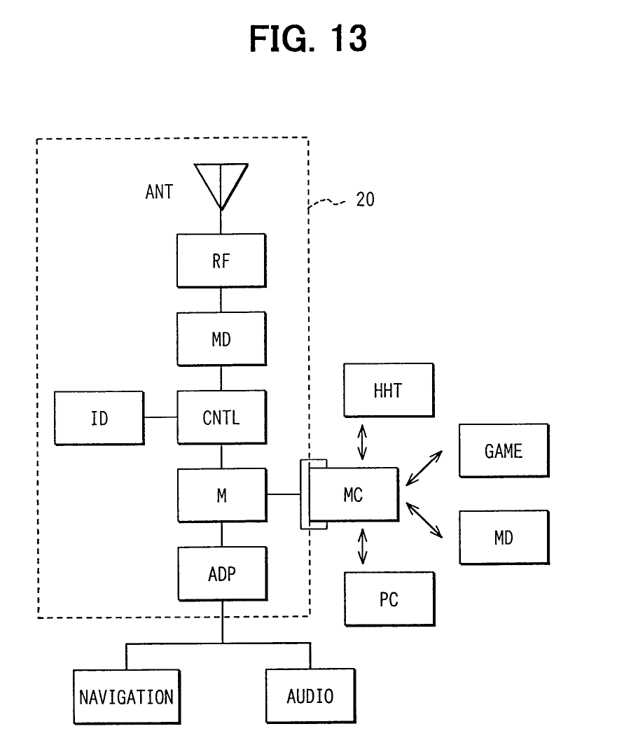

Next, a first sample of structure of an in-vehicle device 20 will be described with reference to FIG. 13. This in-vehicle device has an antenna ANT, a RF circuit RF, a modem MD, a control circuit CC, a memory M and an in-vehicle network adapter ADP. The control circuit CC conducts a process for sending a one-time password and an ID number stored in the memory M to the control server when getting in a download cell. Also, the control circuit controls the memory M to memorize the downloaded data therein. The data memorized in the memory M is sent to a navigation system and an audio system through the in-vehicle network adapter ADP, and can be taken outside by being memorized in a memory card MC. Namely, the downloaded data can be used in a hand-held terminal HHT such as a PDA, a game instrument, a music player such as an MP3 player, or a personal computer.

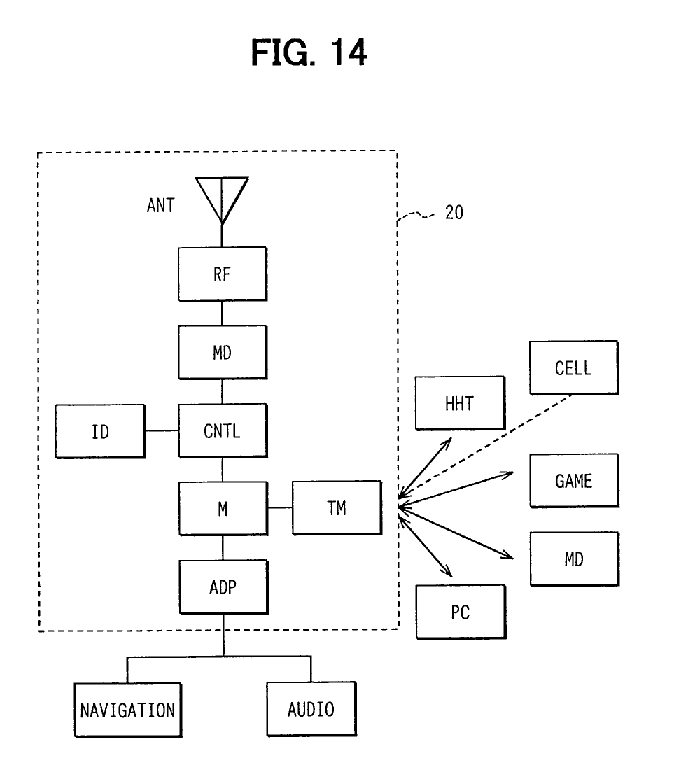

A second sample of structure of an in-vehicle device 20 will be described with reference to FIG. 14. In this example, an in-vehicle communication tool, for example, a close range communication tool using Bluetooth or infrared data communication is provided in an in-vehicle device 20 to communicate with a hand-held terminal, a cell phone, a game instrument, a music player and a personal computer for using the downloaded data outside of the in-vehicle device 20. In this example, a one-time password can be input to the in-vehicle device from the cell phone through the in-vehicle communication tool.

In the above-mentioned embodiment, the in-vehicle device can be used as a memory and a downloading tool. The data memorized in the in-vehicle device can be used in many ways described above as well as in a vehicle.

In the above-mentioned embodiment, although the procedure for purchasing the data through the first radio waves system is conducted by the cell phone, other hand-held terminals also can be used for purchasing the data. Moreover, the device to which the data is to be downloaded is not limited to the in-vehicle device. Other mobile devices can be used for a device to be downloaded with the data that is acceptable in the high speed second radio waves system. For example, assume that the mobile device is the one capable of being carried in a bag. In this situation, when the user moves with the mobile device in the bag by using a train, a bus, a taxi or a airplane, and when the user gets into a downloading area in a high-speed radio waves communication system, such as a station, a predetermined place, an airport or the like, the data can be delivered automatically to the mobile device in the bag.

In the above-mentioned embodiments, a circuit switching type network is used as the first radio transmission system. A packet telecommunication also can be used as the first radio transmission system.

While the present invention has been shown and described with reference to the foregoing preferred embodiment, it will be apparent to those skilled in the art that changes in form and detail may be therein without departing from the scope of the invention as defined in the appended claims.

What is claimed is:

1. A method for downloading data comprising the steps of:
sending a request for download of data and first specified information which specifies a mobile device to be downloaded with the data from a hand-held device through a first communication network;
primary receiving the request and the specified information through the first communication network at a predetermined server connected to a second communication network capable of communicating with the first network;
later receiving second specified information which is sent from the mobile device when the mobile device is located in any one of a plurality of download cells each of which is discrete from the others through an access point performing communication with the mobile device;
confirming whether the second specified information received at the later receiving step is identical to the first specified information received at the primary receiving step; and
delivering the requested data to the mobile device through the access point after confirming the second specified information received at the later receiving step is identical to the first specified information received at the primary receiving step.

2. A method for downloading data according to claim 1, wherein the hand-held device receives a reservation notice for the download of the data after sending the request, wherein the reservation notice is sent with the second specified information when the mobile device is located in any one of the plurality of download cells, and the reservation notice is used for confirming whether the mobile device is the one to be downloaded with the data.

3. A method for downloading data according to claim 2, wherein the reservation notice is a one-time password which is set at every reception of a request for download of data.

4. A method for downloading data according to claim 1, wherein the first network is provided for a user who contracts with the first network, and the second network is provided as a random accessible type public network.

5. A method for downloading data according to claim 4, wherein the random accessible type public network is the Internet, the hand-held device is a device capable of web-browsing and sending the request and the first and second specified information to the predetermined server through the first and second communication networks.

6. A method for downloading data according to claim 1, wherein after the delivery of the data to be downloaded is interrupted, the delivery of the data resumes after performing the confirmation by using the second specified information when the mobile device gets into any one of the plurality of download cells again.

7. A method for downloading data according to claim 1, further comprising:
informing a control device, which is provided to be connected to the first communication network to control communication by the hand-held device, of a charging notice for the download of the data by using a hand-held device specifying information that is used when the hand-held device conducts communication through the first communication network.

8. A method for downloading data according to claim 1, wherein in a situation the request for the download includes retrieving of data, the result of the retrieving is the data to be downloaded to the mobile device.

9. A method for downloading data according to claim 1, wherein cache servers are provided, each of which is connected to a respective access point provided for each download cell, and each cache server stores the data to be downloaded to the mobile device, wherein the data to be downloaded is delivered from one of the cache servers to the mobile device through the respective access point connected to the one cache server.

10. A method for downloading data according to claim 1, further comprising:
sending the requested data to be downloaded to the mobile device to cache servers each of which is connected to a respective access point, wherein the delivery of the data is performed by one of the cache servers through the respective access point connected to the one cache server.

11. A method for downloading data according to claim 1, further comprising:
sending the requested data to be downloaded to the mobile device to at least one cache server located within a predetermined area where the hand-held device, which sent the request for the download of the data, exists.

12. A method for downloading data according to claim 1, wherein in a situation where the data requested by the hand-held device is real-time information, the delivery of the requested data is performed by a real-time server to the mobile device that delivers the real time information.

13. A method for downloading data according to claim 1, wherein the predetermined server receives the request for the download of the data and the first specified information for the mobile device to which the data is to be downloaded from a purchase reservation server provided on the first communication network that receives the request and the first specified information from the hand-held device.

14. A method for downloading data comprising the steps of:
sending a request for download of data and first specified information for specifying a mobile device to be downloaded with the data from a hand-held device through a first network for a communication tool, wherein the first network is used by a user who contracts with the first network;
primary receiving the request and the first specified information through the first communication network;
later receiving second specified information which is sent from the mobile device when the mobile device is located in any one of a plurality of download cells each of which is discrete from the others through an access point performing communication with the mobile device;
confirming whether the second specified information received at the later receiving step is identical to the first specified information received at the primary receiving step; and
delivering the requested data to the mobile device through the access point after confirming the second specified information received at the later receiving step is identical to the first specified information received at the primary receiving step.

15. A method for downloading data according to claim 14, wherein the hand-held device receives a reservation notice for the download of the data after sending the request, wherein the reservation notice is sent with the second specified information when the mobile device is located in any one of the download cells, and the reservation notice is used for confirming whether the mobile device is the one to be downloaded with the data.

16. A method for downloading data comprising the steps of:
sending a request for download of data from a hand-held device through a first communication network;
receiving the request sent from the hand-held device at a predetermined server connected to a second communication network capable of being connected to the first network;
preparing the data requested by the hand-held device through the first communication network;
receiving specified information which is sent from the mobile device to inform that the mobile device is supposed to be downloaded with the data when the mobile device is located in any one of download cells each of which is discrete from the others through an access point performing communication with the mobile device; and
delivering the requested data to the mobile device through the access point.

17. A method for downloading data according to claim 16, the first network has an accessible area wider than that of each download cell.

18. A method for downloading data according to claim 16, wherein the hand-held device receives a reservation notice for the download of the data after sending the request, wherein the reservation notice is sent with the specified information when the mobile device is located in any one of the download cells, and the reservation notice is used for confirming whether the mobile device is the one to which the data is to be downloaded.
